(19) United States
(12) Patent Application Publication
(10) Pub. No.: US 2014/0278485 A1
(43) Pub. Date: Sep. 18, 2014

(54) SYSTEMS AND METHODS FOR MARKET PARTICIPANT-BASED AUTOMATED DECISIONING

(71) Applicant: Strathspey Crown LLC, Newport Beach, CA (US)

(72) Inventors: Robert Grant, Laguna Beach, CA (US); David Mordaunt, Los Gatos, CA (US); Jennifer Mons, San Clemente, CA (US)

(21) Appl. No.: 14/189,336

(22) Filed: Feb. 25, 2014

Related U.S. Application Data
(60) Provisional application No. 61/778,183, filed on Mar. 12, 2013.
(60) Provisional application No. 61/782,975, filed on Mar. 14, 2013.
(60) Provisional application No. 61/785,176, filed on Mar. 14, 2013.

(51) Int. Cl. G06Q 50/22; G06Q 10/06

(52) U.S. Cl. CPC G06Q 50/22; G06Q 10/06393
USPC 705/2

(57) ABSTRACT

One embodiment includes an environment and system for analyzing, including predictive analysis of, various data associated with industry participants, processing the data to generate one or more participant influence scores and/or to identify key opinion leaders, and for utilizing such data to assess or optimize a practice, company, product or service, and/or to automate decisions regarding a company's operations, product development, marketing and/or allocation of resources.

### CROSS-REFERENCE TO RELATED APPLICATIONS

This application claims benefit of priority to U.S. Patent Application No. 61/778,183, filed on Mar. 12, 2013, entitled “SYSTEMS AND METHODS FOR MARKET PARTICIPANT-BASED AUTOMATED DECISIONING” and claims benefit of priority to U.S. Patent Application No. 61/782,975, filed on Mar. 14, 2013, entitled “SYSTEMS AND METHODS FOR MARKET ANALYSIS AND AUTOMATED BUSINESS DECISIONING” and claims benefit of priority to U.S. Patent Application No. 61/785,176, filed on Mar. 14, 2013, entitled “SYSTEMS AND METHODS FOR MARKET ANALYSIS AND AUTOMATED BUSINESS DECISIONING”, each of which is hereby incorporated herein by reference in its entirety.

### GENERAL BACKGROUND OF CERTAIN EMBODIMENTS

Within the healthcare industry, products and procedures may generally be classified into two sectors—a reimbursement sector and a private-pay sector. The reimbursement sector may include medical need-related products and procedures, which may be covered and reimbursed by government and/or private insurance. The private-pay sector may include non-medical, enhancement products and procedures, which are not generally covered by insurance, but are paid out-of-pocket. Certain products or procedures may overlap the two sectors, such as products where the medical need is assessed on a case-by-case basis.

### FIELD OF THE INVENTION

The disclosure generally relates to an environment and system for analyzing, including predictive analysis of, various data associated with industry participants, processing the data to generate one or more participant influence scores and/or to identify key opinion leaders, and for utilizing such data to assess or optimize a practice, company, product or service, and/or to automate decisions regarding a company's operations, product development, marketing and/or allocation of resources.

### SUMMARY OF CERTAIN EMBODIMENTS

One embodiment discloses a system for generating an influence score for a participant, the system comprising: a data store that stores information associated with a plurality of participants, wherein at least a portion of the information associated with each participant relates to participation of the participant in an interactive community; and a computing device in communication with the data store and that is configured to: determine a participant reputation and influence score associated with each of the one or more of the plurality of participants, wherein the participant reputation score for a given participant is based at least in part on at least one of a volume of business associated with the participant, a number of publications by the participant, quality of input received by the participant, or feedback received regarding the participant; determine a participant participation score associated with each of the one or more of the plurality of participants based at least in part on information retrieved from the data store; and generate a participant influence score associated with each of the one or more of the plurality of participants based at least in part on the determined participant reputation scores and the determined participant participation scores.

One embodiment discloses a computer-implemented method for generating a report assessing a target, the computer implemented method comprising, as implemented by one or more computing devices configured with specific executable instructions: electronically receiving feedback regarding at least one product of a target, wherein the feedback is provided by one or more of a plurality of participants; determining a participant influence score associated with one or more of the plurality of participants; and generating a target assessment report or initiating an automated decision action based at least in part on the received feedback and the participant influence scores.

One embodiment discloses a non-transitory computer-readable medium having a computer-executable component for analyzing a target, the non-transitory computer-readable medium comprising: a feedback component for electronically receiving feedback regarding at least one product of a target, wherein the feedback is provided by one or more of a plurality of participants; a scoring component for: determining a participant reputation score associated with each of the one or more of the plurality of participants; and determining a participant participation score associated with each of the one or more of the plurality of participants, wherein the participant participation score for a participant is determined based at least in part on an amount of feedback previously provided by the participant; and an action generation component for generating a target assessment action based at least in part on the received feedback, the determined participant reputation scores and the determined participant participation scores.

### BRIEF DESCRIPTION OF THE DRAWINGS

Specific embodiments will be described with reference to the following drawings:

FIGS. 1A and 1B are illustrative operating environments that include an analysis system and an interactive community platform system in communication with various participant systems, an inventory tracking system, third-party data sources and a user device.

FIG. 2 is one embodiment of illustrative data flow to the analysis system 100 from one or more sources and from the analysis system 100 to one or more users or systems.

FIG. 3 is one embodiment of a flow diagram of an illustrative method for determining participant influence scores and/or using aggregated participant data to generate reports or make business decisions.

FIG. 4 is one embodiment of a flow diagram of an illustrative method for generating an influence score for each of one or more participants.

### DETAILED DESCRIPTION OF THE EMBODIMENTS

Aspects of the present disclosure relate to an interactive community platform and/or social network that enables a number of participants with shared interests or business areas (such as specialty physicians) to interact with each other and/or the platform. An analysis system, as disclosed herein, may be in communication with the interactive community platform and may leverage data from the platform to conduct market research and/or to at least partially automate various business decisions of a company. According to some embodiments, the analysis system may be considered a crowd intelligence engine whose information is utilized to make better business decisions. The interactive community platform may be considered, in some embodiments, a forum where physicians (or industry participants in any targeted industry, in some embodiments) may engage with one another and/or with investment or corporate entities in a manner that may directly impact the direction of a company, a product or a service, or may improve the participant's own practice or business.

According to some embodiments, an analysis system described herein may collect and analyze industry participants' opinions to refine a company's strategy and/or to focus on delivering services and offerings that matter most to customers. Accordingly, the analysis system may provide market participants and/or customers with a voice that affects a company's business decisions and/or investment decisions. The participants may thereby collectively drive strategy in a number of functional areas of a company with a focus of delivering the best products and/or services to consumers. In some embodiments, surveys may be conducted via crowd intelligence platform to gather customer or participant opinions on a given company's products (or a portfolio of companies' products) compared to the competition, as well as relative to customer needs. In some embodiments, scores described herein may be used to compare a given participant (such as a doctor) across many platforms and data types to determine what makes a given participant different than others within the participant's community, within a given market or region, and/or within a given industry as well as to weight feedback provided by such participant

Aspects of the disclosure include processing and analyzing product and strategy feedback, feedback on business practices, automated inventory data and/or other data in order to generate scores and reports regarding a market participant, a target product, a marketing campaign, manufacturing and inventory practices, a target procedure or target company. In some embodiments, one or more generated reports may identify portions or aspects of a target's practice, products, procedures or business processes that could be altered in order to optimize product effectiveness, sales, market share and/or profitability. Accordingly, aspects of the present disclosure may provide data, scores and/or reports used to drive decisions regarding a company's operations, product development, marketing and/or allocation of resources. In other embodiments, one or more generated scores and/or reports may indicate a target company's viability as a profitable investment, and may be used in whole or in part to make an acquisition or investment decision.

Aspects of the present disclosure may enable analysis of collective feedback received from a number of individuals regarding a product, service and/or company, as well as other data described herein, to be used to drive business decisions of a company. The feedback of each individual or participant may be weighted, in some embodiments, according to an influence score generated for the participant by the analysis system, as described herein. Accordingly, aspects of the present disclosure may enable a company to utilize crowd intelligence or “crowd IQ” in order to make business decisions that improve the company's market share in a given industry. In some embodiments, an analysis system described herein may mine data related to a number of industry participants to inform the company's decisions related to operations, marketing, product design, capital investments and other investments, advertising, inventory management, and/or other business decisions. The analysis system may be further configured, in some embodiments, to analyze data that provides an objective indication of whether one or more investment or business decisions have resulted in an increased market share. For example, aspects of the present disclosure may provide a real time or near-real time indication of the return on investment (“ROI”) of marketing, product design, operational and/or other decisions based on actual market data. Accordingly, aspects of the present disclosure may enable a company to align its resources and efforts with customers' desires. In some embodiments, the received feedback and/or other data may be modified to remove personally-identifiable information and then sold or otherwise provided to a third-party.

While the example of healthcare products and procedures are often used herein as examples of a target's products or services, in other embodiments, an analysis system as disclosed herein may be configured to analyze data for targets related to any industry. Aspects of the present disclosure, according to some embodiments, may be particularly suited to any industry where product sales are driven by the provider instead of by the consumer. In some embodiments, feedback may be received from industry professionals, providers or other participants from within a given target's industry, rather than from patients, physicians or other medical professionals.

According to some embodiments, an analysis system, as disclosed herein, may be configured to analyze a variety of data to determine whether the target is a worthwhile investment option and/or to drive various business decisions of the target company. In some embodiments, the target may be a product, procedure and/or company in the healthcare industry. Within the healthcare industry, products and procedures may generally be classified into two sectors—a reimbursement sector and a private-pay sector. The reimbursement sector may include medical need-related products and procedures, which may be covered and reimbursed by government and/or private insurance. The private-pay sector may include non-medical, enhancement products and procedures, which are not generally covered by insurance, but are paid out-of-pocket. Certain products or procedures may overlap the two sectors, such as products where the medical need is assessed on a case-by-case basis.

The terminology used in the description presented herein is not intended to be interpreted in any limited or restrictive manner, simply because it is being utilized in conjunction with a detailed description of certain specific embodiments. Furthermore, embodiments may include several novel features, no single one of which is solely responsible for its desirable attributes or which is essential to practicing the systems and methods described herein.

### Example Computing Systems and Environments

FIG. 1A illustrates an example configuration of an analysis system 100A and interactive community platform 104A in communication with a user device 170A, an inventory tracking system 166A, third-party data sources 168A and participant systems 162A, 163A and 164A via a network 160. As illustrated, the analysis system 100A includes a data aggregation module 150A, score and ranking module 152A, optimization module 154A and action generator module 156A. Each of the systems and modules illustrated in FIG. 1A may be similar to those systems and modules with corresponding numbers described in more detail below with reference to FIG. 1B. The operating environment illustrated in FIG. 1A may be one in which the participant systems are operated by participants outside of the healthcare field, rather than the examples of participant systems described below with reference to FIG. 1B.

In the illustrated embodiment, the interactive community platform 104 may provide a social network service and/or may enable participants (such as physicians or other participants utilizing participant systems 162-164) to engage in activities such as providing product or service feedback, voting, gaining following for an idea, completing and/or developing surveys, completing online training or education, authoring blogs or other content, providing or tracking information regarding their practice or business, connecting with and sharing content within a selective group of like-minded participants, and/or other features. In some embodiments, participants may be members of smaller networks or groups based on one or more of a specialty, experience level, a category expertise, and so forth. In some embodiments, the platform may encourage content engagement through rating and commenting of content, and may also enable searching, categorizing or tagging content. As will be discussed below, a participant may be encouraged to actively participate in various aspects of the platform in order to increase the participant's influence score.

In the embodiment shown in FIG. 1A, the analysis system 100 is configured to execute the data aggregation module 150A to receive and process data regarding participants and/or target companies, products or services, where the data may be received from the interactive community platform 104A, the third-party data sources 168A, the inventory tracking system 166A and/or other sources. In the illustrated embodiment, the analysis system 100A is further configured to execute score and ranking module 152A in order to determine participant reputation scores, participant participation scores and/or participant influence scores based at least in part on data retrieved from various sources, including data processed by the data aggregation module and stored in mass storage device. While examples of physicians as participants will be used below, it will be appreciated that when utilized in other industries or fields, the scores may correspond to market participants other than physicians, patients or other entities in the healthcare field. The analysis system 100A may be further configured to execute the target optimization module 154A in order to determine ways in which a target company could improve or optimize a product, line of products, a procedure, the target's marketing strategy, and/or another aspect of the target's business. The analysis system 100A, in the illustrated embodiment, is further configured to execute the action generator module 156A in order to generate one or more reports regarding a target, which may be used to assess an investment opportunity, make an acquisition decision, make operating decisions, and/or for marketing decisions or other purposes. One or more of the illustrated modules 150A, 152A, 154A and/or 156A may, depending on the embodiment, implement any other functionality described elsewhere in this specification.

FIG. 1B illustrates an example configuration of an analysis system 100 and an interactive community platform 104 in communication with a user device 170, an inventory tracking system 166, third-party data sources 168 and participant systems 162-164. Depending on the embodiment, other systems for calculating scores for various participants and/or for evaluating target products, procedures or companies, as described herein, may include additional or fewer components than are illustrated in the example of FIG. 1B. The user device 170, inventory tracking system 166, interactive community platform system 104 and participant system 162-164 may include a personal computer, a laptop computer, a server, a cell phone, a personal digital assistant, a media player, a touch screen device, a tablet, and/or any other computing device. As one example, third-party data sources 168 may include data related to public records, a social networking service, business records, scholarly or academic publications, industry information, market and financial data, corporate earnings data, presentation data, professional journals or publications, patents and related publications, and/or other types of data regarding companies, doctors, businesses, medical groups, individuals, etc.

The analysis system 100 includes, for example, a personal computer that is IBM, Macintosh, or Linux/Unix compatible or a server or workstation. In one embodiment, the analysis system 100 comprises a server and/or a laptop computer, for example. In one embodiment, the exemplary analysis system 100 includes one or more central processing unit (“CPU”) 105, which may each include a conventional or proprietary microprocessor. The analysis system 100 further includes one or more memory 130, such as random access memory (“RAM”) for temporary storage of information, one or more read only memory (“ROM”) for permanent storage of information, and one or more mass storage devices 120, such as a hard drive, diskette, solid state drive, or optical media storage device.

According to FIG. 1B, information is provided to the analysis system 100 and the interactive community platform 104 over the network 160 from one or more data sources. The data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, an object-oriented database, and/or a record-based database.

In the embodiment of FIG. 1B, the analysis system 100 also includes data aggregation module 150, score and ranking module 152, target optimization module 154 and action generator module 156 that may be stored in the mass storage device 120 as executable software codes that are executed by the CPU 105. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Typically, the modules of the analysis system 100 are connected to the computer using a standard based bus system. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of analysis system 100 may be combined into fewer components and modules or further separated into additional components and modules.

The analysis system 100 is generally controlled and coordinated by operating system software, such as Windows XP, Windows Vista, Windows 7, Windows Server, Unix, Linux, SunOS, Solaris, or other compatible operating systems. In Macintosh systems, the operating system may be any available operating system, such as MAC OS X. In other embodiments, the analysis system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary analysis system 100 may include one or more commonly available input/output (I/O) devices and interfaces 110, such as a keyboard, mouse, touchpad, and printer. In one embodiment, the I/O devices and interfaces 110 include one or more display devices, such as a monitor, that allows the visual presentation of data to a user. More particularly, a display device provides for the presentation of GUIs, application software data, and multimedia presentations, for example. The analysis system 100 may also include one or more multimedia devices 140, such as speakers, video cards, graphics accelerators, and microphones, for example.

In the embodiment of FIG. 1B, the I/O devices and interfaces 110 provide a communication interface to various external devices. In the embodiment of FIG. 1B, the analysis system 100 is electronically coupled to a network 160, which comprises one or more of a LAN, WAN, and/or the Internet, for example, via a wired, wireless, or combination of wired and wireless, communication link. The network 160 communicates with various computing devices and/or other electronic devices via wired or wireless communication links. Additionally, it should be noted that in some embodiments, the analysis system may be executed by one more virtual machines implemented in a hosted computing environment, which may also be referred to as a cloud computing environment. The interactive community platform 104 may include components similar to those discussed above with reference to analysis system 100. In some embodiments, the analysis system may provide the functionality of the interactive community platform, such that a separate community platform system 104 is not needed.

### Example Methods

FIG. 2 is one embodiment of illustrative data flow to the analysis system 100 from one or more sources and from the analysis system 100 to one or more users or systems. The data may be received, for example, from the interactive community platform 104, one or more third-party data sources 168 and/or one or more participant systems. The analysis system may receive data related to each of a potentially large number of different participants, such as physicians, that interact with the interactive community platform 104. As illustrated, the data received or retrieved for each of a number of participants may include one or more of the following: purchasing volume or business volume information; peer influence data; reputation information; ethics information; number of and/or number of citations to publications, papers or research authored; presentations given or podium time; the number of patents filed or issued; feedback from end-consumers (for example, patients in the case of physicians); education module results; accuracy in case studies or clinical games; participation in votes, blogs, posts, surveys, or other online interaction with the interactive community platform and/or other social network service; feedback regarding products or services provided; and/or investment levels in one or more companies.

As illustrated in FIG. 2, the analysis system 100 may process and analyze the received data to determine influence scores for one or more participants, identify key opinion leaders among the participants, and/or to generate one or more reports regarding a target company, product, procedure or service based on the aggregated information. In some embodiments, the report may leverage feedback provided by a number of participants regarding the target and weigh each participant's feedback based at least in part on a calculated influence score associated with that participant.

As further illustrated in FIG. 2, the analysis system 100 may output, send or provide the generated information to another system, individual or entity. The resulting data, scores and/or report may be used to accomplish one or more of the following, depending on the embodiment: make business decisions related to operations, product development, marketing and/or allocation of resources; determine “x factors” or aspects of a participant, practice, company, product or service that are likely to increase market share for a participant, practice, company, product and/or service; optimize a participant's practice or business; optimize a target product or service; optimize a target company; analyze a company, product and/or service for acquisition or investment; conduct market research; and/or identify market trends.

FIG. 3 illustrates an illustrative operating environment 300 in which analysis system 100 determines participant influence scores and/or uses aggregated participant data to generate reports or make business decisions based at least in part on information received from the interactive community platform 104, third-party data sources 168, participant systems 162-164 and/or inventory tracking system 166. While the illustrative methods of FIGS. 3 and 4 will be described below with reference to an embodiment in which the participants are physicians, in other embodiments, similar methods may be implemented by the analysis system 100 in order to generate scores, reports and/or assessments based on feedback and information associated with participants other than physicians (and potentially outside of the healthcare or medical field). As illustrated, the users of participant systems 162-164 may interact with the interactive community platform 104, which may include connecting with others in a specialty social network, posting information, completing surveys or feedback regarding one or more products or procedures, voting on various decisions related to a company or industry, completing online training or education modules, and/or other features. Depending on the embodiment, feedback and interaction may be a provided by greater or fewer participant systems than the three participant systems illustrated in FIG. 3. Each of participant systems 162-164 may be operated, for example, by a participating doctor that desires to interact with like-minded individuals and/or has agreed to provide feedback to the analysis system 100 regarding potential target companies, products and/or procedures. According to some embodiments, the participating doctors may be stakeholders in a business venture and/or investment portfolio associated with the analysis system 100.

In some embodiments, each physician may provide multivariable feedback for one or more products and/or procedures. The feedback may be received, for example, via one or more user interfaces generated by the analysis system 100 and/or community platform 104. Some such user interfaces may prompt the physician to answer questions regarding the product or procedure and to provide structured and/or freeform responses. According to some embodiments, the feedback may include questions directed to certain predefined dimensions of the product, and may vary based on the specific product in question. For example, one or more user interfaces may prompt the physician to answer questions indicating which product features are most important to the physician, and which features are least important to the physician. Accordingly, the received feedback may indicate not only whether the physician considers the product favorably, but also what specific aspects of the product are liked or disliked by the physician. For example, the feedback may indicate the physician's opinion regarding the appearance of the product, effectiveness of the product, ease of use, speed, cost and/or other aspects or features of the product.

In the illustrated embodiment, the participant systems 162-164 provide real-time or near real-time automated inventory data to an optional inventory tracking system 166. The inventory data may include, for example, an indication of the products that are currently in inventory at a given's physician's office. In some embodiments, the participant systems may track inventory based at least in part on automated systems employing radio-frequency identification (“RFID”) tags, bar codes, QR codes, and/or other automated identification markings on the inventory. Automated inventory tracking may be beneficial, for example, if a physician stores a large amount of inventory at a given time, and/or has expensive products in inventory. An inventory tracking system may help to identify when products consumed, are stolen and/or when products expire. In some embodiments, the inventory tracking system 166 may associate a product with a specific patient and date. The inventory tracking system 166 may be configured to automatically send an order for a replacement product in response to a product being sold, expiring or being stolen. The inventory data may also be used to score the physicians. For example, the opinion of a physician that uses more inventory may be weighed higher than a physician that uses a minimal amount of inventory. In other embodiments than that illustrated in FIG. 3, one or more of the participant systems may not be configured to provide inventory data, or may provide inventory data in a batch process instead of in real time. The real-time inventory data may also be used to determine the efficacy of marketing campaigns on actual product consumption, which may be much more effective than just tracking product sales, where channel stuffing can be an issue. In addition, the inventory tracking data may enable tracking a patient journey from consideration to action by segment.

As illustrated in FIG. 3, the analysis system 100 receives a variety of disparate data associated with the participants from third-party data sources 168, the interactive community platform 104 and the inventory tracking system 166. The analysis system 100 may generate participant scores and/or generate one or more automated reports and/or business decision analyses based at least in part on the information received from the participant systems 162-164, the third-party sources 168 and optionally based on aggregated market share data sent by the inventory tracking system 166. In some embodiments, the analysis system 100 may generate a customer alignment matrix based on the product feedback received from one or more of the participant systems. The analysis system 100 may also be used to at least partially automate one or more various business decisions of a company. Score and report generation will be discussed in more detail below with reference to FIG. 4.

The analysis system may additionally or alternatively identify key opinion leaders among the participants. Once the analysis system has generated one or more reports, scores or other information, the analysis system provides the generated data to the user computing device 170, which may be operated by one or more individuals that interpret and analyze the report(s) to make investment or acquisition decisions regarding the target and/or to make decisions regarding operations, marketing, product design, company resource allocation, capital investment, and/or inventory management of the target.

FIG. 4 is a flow diagram of an illustrative method implemented by the analysis system 100 for generating influence scores for participants and/or for assessing a target and generating one or more reports regarding the target. The illustrative method begins at block 402, where the analysis system 100 receives data regarding one or more participants. The data for each participant may include data relating to the participant's community platform participation, publications, reputation, and/or business data, among others. Various data types that may be received regarding a participant are discussed above with reference to FIG. 2.

In some embodiments, the analysis system 100 may additionally receive feedback regarding a product or procedure of a target company from one or more participants (which may be received via the interactive community platform 104). The feedback may be received and processed, according to one embodiment, by the data aggregation module 150 from one or more of the participant systems 162-164. In some embodiments, the feedback from each participant may be received via one or more user interfaces generated by the analysis system 100 or interactive community platform 104 for display on the participant's computing system, such as via a browser interface or a customized application. In other embodiments, the feedback may be received via email, phone, in-person discussion and/or other communication methods. As discussed above, the feedback from each participant regarding a given product may generally indicate the participant's opinion of the product as a whole, as well as the specific aspects of the product that the participant likes or dislikes. According to the illustrative method of FIG. 4, the analysis system 100 may optionally receive product inventory data at block 404, such as real-time product inventory data received from the inventory tracking system 166.

At block 406, the analysis system 100 determines a participant reputation score for each of the one or more physicians or other participants from whom information has been received. The reputation scores may be generated, in some embodiments, by the score and ranking module 152. According to some embodiments, the reputation score for a given physician or other participant may be based at least in part on the number and/or popularity of publications, presentations and/or speeches by the physician or other participant. Information considered in generating the reputation score may be received, depending on the embodiment, from one or more data sources associated with the analysis system 100 and/or from one or more third-party data sources 168, such as websites, academic or research databases, and/or other sources. In some embodiments, the reputation score for a given participant may be based at least in part on the volume of purchases by the participant from a given target company or within a given industry. The reputation score for a given participant may additionally or alternatively be based at least in part on a likeability index indicating how likeable each participant has been found to be based on the opinion of one or more individuals, such as founders of an entity that will evaluate a generated target report. In some embodiments, the reputation score for a given participant may be based at least in part on the participant's financial wherewithal and/or an investment amount. As an example, the participation score in one embodiment may be based at least in part on the participant's purchasing volume in a relevant area (such as a physician's volume of cash-pay business), peer influence, investment level, reputation and ethics, number or amount of publications, podium time, number of peer reviewed papers, presentations, patents filed or issued, patient feedback, and/or accuracy in clinical games or case studies.

At block 408, the analysis system 100 determines a participation score for each of the one or more participants (such as physicians) from whom information has been received. According to one embodiment, the participation score may generally represent the participant's participation level with the analysis system 100 and/or with the community of participants that interact with the analysis system 100. The participation score for a given participant may be determined based at least in part on the amount of time that the participant has spent interacting with the analysis system 100, the number of connections or followers associated with the participant within a social network, the amount of involvement or participation in surveys or feedback requests generated by the analysis system 100, the participant's involvement in voting activities associated with the analysis system 100, and/or the closeness of the participant to the participant population (for example a physician population, such as, whether the given participant is an outlier in one or more areas. In some embodiments, the participant participation score for a given participant may also be based in part on the amount of product(s) the participant used for specific targets.

At block 410, the analysis system 100 may generate an influence score for each physician or other participant, which may be considered a “Q-score,” based on a weighted average of the participant's reputation score and participation score. A relatively high influence score may indicate, for example, that a given physician is an influential doctor with a competitive drive. In other embodiments, an influence score may be generated based on one or more of the criteria described above with respect to generating a reputation score or participation score, and a separate reputation and/or participation score may not be determined. In some embodiments, the influence scores may be fitted to a traditional or weighted bell curve or other function for ranking or grouping participants based on influence.

Once the analysis system 100 has generated the influence scores, the illustrative method proceeds to block 412. At block 412, the analysis system 100 generates one or more target assessment reports, identifies key opinion leaders and/or determines a business decision to be made based at least in part on the received information and the influence scores.

A business decision may include, for example, decisions related to operations, marketing, product design, research and development, manufacturing practices, allocation of company resources, capital investments and other investments, advertising, inventory management, and/or other business decisions. For example, some example decisions may include required online training sessions, setting of future budgets, deciding what inventory to purchase, deciding when to purchase certain products, deciding which distributor to use, deciding where to distribute resources, deciding which regions or practices to disburse products to, choosing what ads to use, where to use them, and when to air them, developing messaging that is most attractive to customers, physicians, patients, and/or key opinion leaders, and/or other decisions.

A generated report may include, for example, an indication of how desirable a target company would be for a potential acquisition or investment. In some embodiments, one or more of the generated reports may be specific to a single product or procedure of a target company, may be directed to a target company as a whole, or may be directed to an industry or field that includes multiple companies. Information included in the generated report may include, for example, aggregated survey or feedback results, which may be weighted based on one or more of the scores determined for each participant that provided feedback. In other embodiments, information from participants that are considered outliers and/or did not provide a minimum amount of feedback may be excluded from the results and/or weighed significantly lower than the other participants. In some embodiments, one or more generated reports may include a ranking of multiple target companies indicating how desirable each target would be for investment or acquisition.

One or more of the generated reports may, in some embodiments, include an indication of target optimization opportunities, such as suggested optimizations or changes to the operations, marketing, and/or product design of the target based on the feedback received from the participants. The optimization opportunities may be determined, for example, by the target optimization module 154. In some embodiments, a target optimization report may indicate that the company is overachieving on certain aspects of a product that are not particularly important to the average participant or customer, based at least in part on the participant feedback received, while underachieving on other aspects that are more important to participants or customers. The target optimization module 154 may also correlate this information to cost data for the product to provide and/or assist with recommendations for specific optimizations or changes. In some embodiments, the information included in the target optimization report may be used by the target and/or an acquirer following acquisition in order to optimize the target's products, procedures, marketing and/or operations, and/or to track the effect of product changes as the target evolves.

For example, a generated report may indicate that a product's digital interface readout (costing $2.10) is very easy to read and liked by the vast majority of the reviewing physicians, but that the replacement cap for the product (costing $0.04) is clumsy and difficult to use. Thus, if the target was planning to invest $500,000 in a redesign of the digital interface readout, the acquirer may instead decide to invest $10,000 in a redesign of the replacement cap and hold off on the redesign of the digital interface readout.

### Additional Embodiments

In general, the word “module,” as used herein, refers to logic embodied in hardware or firmware, or to a collection of software instructions, possibly having entry and exit points, written in a programming language, such as, for example, Java, Lua, C, C++ or C#. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the analysis system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by an analysis system, interactive community platform, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

1. A system for generating an influence score for a participant, the system comprising:
a data store that stores information associated with a plurality of participants, wherein at least a portion of the information associated with each participant relates to participation of the participant in an interactive community; and
a computing device in communication with the data store and that is configured to:
determine a participant reputation and influence score associated with each of the one or more of the plurality of participants, wherein the participant reputation score for a given participant is based at least in part on at least one of a volume of business associated with the participant, a number of publications by the participant, quality of input received by the participant, or feedback received regarding the participant;
determine a participant participation score associated with each of the one or more of the plurality of participants based at least in part on information retrieved from the data store; and
generate a participant influence score associated with each of the one or more of the plurality of participants based at least in part on the determined participant reputation scores and the determined participant participation scores.

2. The system of claim 1, wherein the computing device is further configured to:
electronically receive feedback regarding at least one product of a target, wherein the feedback is provided by one or more of the plurality of participants; and
initiate an automated decision action based at least in part by aggregating the feedback from the one or more participants and assigning a weight to feedback received from each participant based at least in part on the influence score for the participant.

3. The system of claim 1, wherein the computing device is further configured to:
electronically receive feedback regarding at least one product of a target, wherein the feedback is provided by one or more of the plurality of participants; and
generate a target assessment report based at least in part by aggregating the feedback from the one or more participants and assigning a weight to feedback received from each participant based at least in part on the influence score for the participant.

4. The system of claim 3, wherein the report assesses a target for potential acquisition.

5. The system of claim 3, wherein the report assesses a target in order to recommend actions related to at least one of operations, marketing, product design, capital investment, and inventory management.

6. The system of claim 1, wherein the participants are physicians.

7. A computer-implemented method for generating a report assessing a target, the computer-implemented method comprising:
as implemented by one or more computing devices configured with specific executable instructions:
electronically receiving feedback regarding at least one product of a target, wherein the feedback is provided by one or more of a plurality of participants;
determining a participant influence score associated with one or more of the plurality of participants; and
generating a target assessment report or initiating an automated decision action based at least in part on the received feedback and the participant influence scores.

8. The computer-implemented method of claim 7, wherein the automated decision action relates to at least one of operations, marketing, product design, capital investment, or inventory management.

9. The computer-implemented method of claim 7, wherein the report assesses a target for potential acquisition.

10. The computer-implemented method of claim 7, wherein the report assesses a target in order to recommend actions related to at least one of operations, marketing, product design, capital investment, and inventory management.

11. The computer-implemented method of claim 7, wherein the participants are physicians.

12. A non-transitory computer-readable medium having a computer-executable component for analyzing a target, the non-transitory computer-readable medium comprising:
a feedback component for electronically receiving feedback regarding at least one product of a target, wherein the feedback is provided by one or more of a plurality of participants;
a scoring component for:
determining a participant reputation score associated with each of the one or more of the plurality of participants; and
determining a participant participation score associated with each of the one or more of the plurality of participants, wherein the participant participation score for a participant is determined based at least in part on an amount of feedback previously provided by the participant; and
an action generation component for generating a target assessment action based at least in part on the received feedback, the determined participant reputation scores and the determined participant participation scores.

13. The non-transitory computer-readable medium of claim 12, wherein generating the target assessment action generates an automated decision action related to at least one of operations, marketing, product design, capital investment, and inventory management.

14. The non-transitory computer-readable medium of claim 12, wherein generating the target assessment action generates a report to assesses a target for potential acquisition.

15. The non-transitory computer-readable medium of claim 12, wherein generating the target assessment action generates report assesses a target in order to recommend actions related to at least one of operations, marketing, product design, capital investment, and inventory management.

16. The non-transitory computer-readable medium of claim 12, wherein the participants are physicians

17. The non-transitory computer-readable medium of claim 12, wherein the target assessment action is generated based at least in part on feedback received from a plurality of participants.

18. The system of claim 1, wherein the participant reputation score for a given participant is based at least in part on a number of publications by the participant

19. The computer-implemented method of claim 7, wherein the feedback is provided by two or more of the plurality of participants.

20. The computer-implemented method of claim 19, wherein a participant influence score is determined for each of the two or more of the plurality of participants.
